(19) United States
(12) Patent Application Publication
(10) Pub. No.: US 2010/0059594 A1
(43) Pub. Date: Mar. 11, 2010

(54) Identity Document with Tissue Reinforcement

(75) Inventor: Jan van den Berg, Gouda (NL)

Correspondence Address: FLIESLER MEYER LLP, 650 CALIFORNIA STREET, 14TH FLOOR, SAN FRANCISCO, CA, 94108, US

(73) Assignee: SDU IDENTIFICATION B.V., Haarlem (NL)

(21) Appl. No.: 12/293,377

(22) PCT Filed: Mar. 19, 2007
(86) PCT No.: PCT/NL07/50114

§ 371 Date: Sep. 17, 2008

(30) Foreign Application Priority Data
Mar. 17, 2006 (NL) 1031396

(51) Int. Cl. G06K 19/02; B29C 67/00; B32B 37/00

(52) U.S. Cl. 235/488; 264/400; 156/60

(57) ABSTRACT

Identity document and also method for producing said identity document. Such a document or bank card is provided with a hole pattern acting as a security feature, for example depicting the face of the rightful holder of that document. In order to prevent cracks or other damage at the position of the hole pattern, it is proposed that a tissue layer be placed at that point. The tissue layer consists of a tissue web made up of intersecting multifilament threads. If a staggered grid pattern of the perforation has to be obtained, the thread directions preferably extend at an angle of approximately 60 or 90°.

This application is a national stage application that claims priority under 35 U.S.C. 371 to Patent Cooperation Treaty Application No. PCT/NL2007/050114, entitled “Identification Document with Tissue Reinforcement,” inventor Jan van den Berg, filed Mar. 19, 2007, and which has been published as Publication No. WO2007/108685, which application is herein incorporated by reference.

The present invention relates to an identity document/bank card comprising a number of interconnected layers and a number of authenticity features, including a perforation, provided in said layers, wherein a reinforcement layer with threads extending near said perforation is provided.

### BACKGROUND OF THE INVENTION

Such an identity document is generally known in the prior art. The Dutch identity card is an example of such a document. A photographic image of the rightful holder is provided on the identity card in this case. In addition, this photograph is repeated as a perforation pattern in another space. This perforation pattern can be obtained by punching or piercing or by a laser beam treatment.

Such a perforation is an easily verifiable authenticity feature.

It has been found, however, that damage can occur if such a card is repeatedly bent or subjected to recurring deformation in another way. This occurs particularly in the case of loose cards, in other words it will occur less readily in the case of passports and the like in which the perforation is provided in a holder page. However, the invention also relates to such documents.

EP 0013021 discloses an identity document made up of various layers, in which tissue-reinforced layers are present and a layer of a hole pattern is provided between said layers. However, it is not possible to obtain the effects of an authenticity feature with such a hole pattern.

### BRIEF SUMMARY OF THE INVENTION

It is the object of the present invention to provide an identity document/bank card which can be subjected to repeated stress at variable temperatures without a perforation provided in it as an authenticity feature being damaged or becoming detached or cracked.

This object is achieved in an identity document of the type described above in that said perforations extend through said reinforcement layer.

According to the present invention, a reinforcement layer with threads is provided at the position of the perforation. Since the perforations preferably extend substantially over the full thickness of the document, or extend over such a distance in the document that this has an effect through the entire document, a security feature is provided. These threads preferably extend between the holes of the perforation. These threads can be monofilament threads, but it is preferable to use multifilament threads. Such threads can be made of any material, and according to a preferred embodiment are made of polyester material. In such a case it is possible to make the threads relatively flat, so that webs occur. Such webs can be of very low thickness, so that it is ensured that the thickness of the identity document/bank card does not exceed the standards set for such documents.

According to a further advantageous embodiment of the invention, the reinforcement layer is in the form of a tissue. More particularly, said reinforcement layer is composed of a tissue of threads extending in two directions, in other words crossing always occurs at the same angle. The angle of the reinforcement threads will be selected depending on the way in which the perforation is made. In the case of a recessed pattern of the perforation, such angle is preferably approximately 60 degrees.

According to a further advantageous embodiment of the invention, the reinforcement layer is provided between two layers, which layers are fused after the reinforcement layer has been provided. Such layers can comprise polycarbonate.

The layer providing strength is preferably composed of a large number of parallel threads, it being possible, as stated above, for each thread to be in monofilament or in multifilament form. The distance between such threads in an advantageous embodiment is preferably approximately 100 μm, so that sufficient space remains for making the perforation.

The perforation can depict any symbol, such as the face of the rightful holder.

The invention also relates to a method for producing an identity document/bank card, comprising providing a carrier on which authenticity features are provided and making a personalized hole pattern in said carrier, the provision of said carrier comprising providing a thread reinforcement at the position of that subsequent hole pattern.

Of course, the thread reinforcement can extend over the entire document. For purposes of production, this is preferable in certain circumstances. In such an embodiment the layer concerned can be made by providing two layer parts, placing the thread reinforcement between them, and fusing said layer parts with the thread reinforcement accommodated between them. This means that there is little or no increase in thickness.

If the entire card is provided with a thread reinforcement, it may be necessary to finish off thread parts projecting from the edge of the card.

The material used for the thread can be a monofilament or a multifilament of glass fibre, aramid or another material. However, it is preferable to use a polyester material. Polyester is easy to perforate with a laser. It cannot after all be ruled out that a part of the hole may be situated in a part of the width of the thread concerned.

### BRIEF DESCRIPTION OF THE DRAWINGS

The invention will be explained in greater detail below with reference to an exemplary embodiment shown in the drawing, in which:

FIG. 1 shows diagrammatically the front side of an identity document;

FIG. 2 shows a cross section of the card shown in FIG. 1 at the position of perforation 3;

FIG. 3 shows a first exemplary embodiment in a cross section at the position of detail III in FIG. 1;

FIG. 4 shows a second exemplary embodiment in a cross section corresponding to that of FIG. 3; and

FIG. 5 shows a laminating press for producing the reinforcement layer according to the present invention.

### DETAILED DESCRIPTION

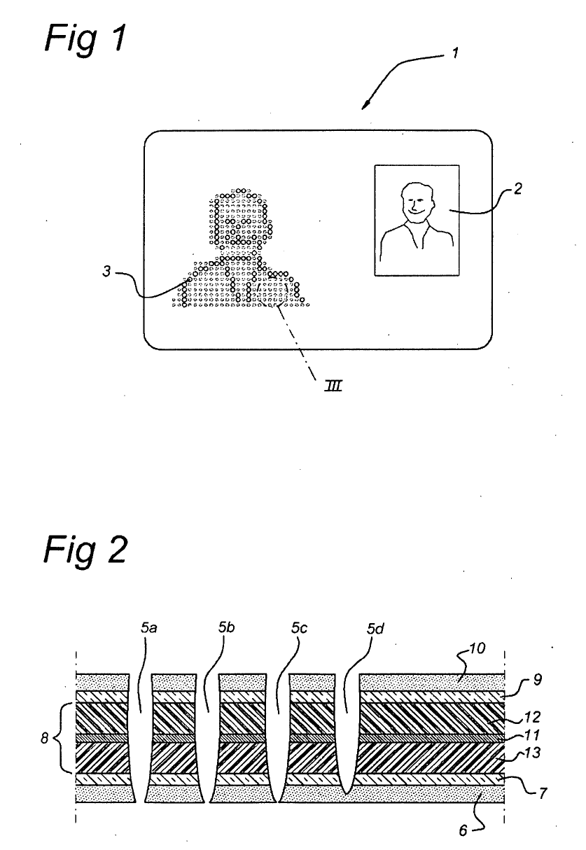

An identity document such as an identity card is indicated by 1 in FIG. 1. The invention also relates to other documents such as bank cards and holder pages of passports.

The photograph of the bearer is indicated by 2. At the position of 3 a perforation pattern is provided, consisting of holes 5 that imitate diagrammatically the silhouette of said photograph. In the present exemplary embodiment this perforation is made by a laser beam.

It has been found that at the position of the perforation pattern 3, with repeated bending or other stress the part inside the perforation pattern can crack and become detached. It should be understood that such identity documents are in use for 5-10 years and during that time are subjected to the greatest stresses, such as mechanical stresses, temperature fluctuations and the like.

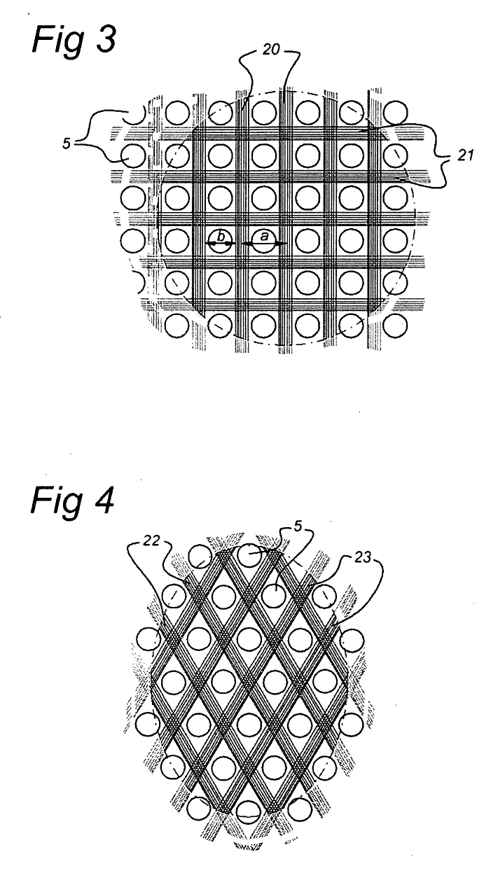

FIG. 2 shows a cross section of the card according to the invention at the position of the perforation. It can be seen from this figure that the card consists of a background layer 6, a transparent layer 7 placed on top of said background layer, on which transparent layer a core layer 8 is then placed, followed by a transparent layer 9 and a background layer 10. The various layers mentioned above can be provided with security features, or can be provided with security features at a later stage. The core layer 8 consists of two layer parts, core layer part 12 and core layer part 13. Accommodated between these two parts is a tissue layer 11, which in practice is surrounded by material from layers 12 and 13. The tissue layer consists of intersecting multifilament threads. The tissue is a particularly flat type of tissue. It can be seen from FIG. 2 that the depth of the holes 5a-5d can vary. In practice, they will preferably all be of the same length. The holes 5a-5d are preferably made between the tissue strips after the assembly of layers has been joined together, being made, for example, with a laser in order to retain the strength of the tissue as much as possible. The multifilament threads of the tissue can be placed at various angles. A first example is shown in FIG. 3, in which the multifilament threads 20 and 21 are placed at an angle of approximately 90°. This goes with the hole pattern shown in FIG. 3. Perforation 5 is provided in such a way here that the holes are situated in line with each other. An image achieved with the perforation is not shown.

FIG. 4 shows a variant. The multifilament threads 22 and 23 in this embodiment extend at an angle of approximately 60°. This goes well with a perforation 5 that is staggered. During the production of the perforation, some of the filaments of a thread can be broken. It is important, however, for one or more filaments ultimately to remain undamaged, in order to safeguard the mechanical properties of the tissue layer.

It is possible for the multifilament threads to extend in another way. A random distribution can be mentioned as an example. It is possible here that the multifilament threads may be broken locally when the holes are being made.

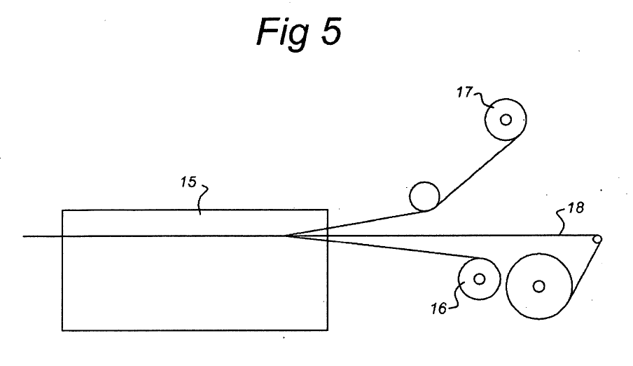

FIG. 5 indicates a laminating press 15. A layer of film material is fed continually to the press from store 16 and 17. A web of tissue material 18 is placed between these two layers. By exerting pressure at raised temperature, a tissue laminate is obtained and, as can be seen from FIG. 2, the tissue web is accommodated completely between the layers 7 and 9.

### EXAMPLE

An identity card is produced by providing two sheets of polycarbonate on rolls 16, 17, each having a thickness of 100 μm, preferably white in colour. A tissue web 18, consisting of polyester tissue, is placed between these two sheets. This tissue web consists of multifilament threads placed at an angle of 90°. The two layers of polycarbonate material are then pressed against each other and fused together at a temperature of 180-210° C. The distance between parallel multifilament threads as shown by reference symbol a in FIG. 3, for example, is approximately 200μ here. At a web width of 100μ for each multifilament thread, a distance b of approximately 100μ remains between adjacent threads, and the holes can be produced. This production of holes is performed by means of a laser.

Although the invention is described above with reference to a preferred embodiment, for anyone skilled in the art variants that lie within the scope of the present invention will immediately spring to mind. For instance, it is possible to provide the card or identity document with all kinds of authenticity features.

Furthermore, it should be understood that rights are expressly requested for variants described in the subclaims independently of the subject matter of the main claim.

1-17. (canceled)

18. Identity document/bank card comprising a number of interconnected layers and a number of authenticity features, including a perforation, provided in said layers, wherein a reinforcement layer with threads extending near said perforation is provided, said perforations extending through said reinforcement layer.

19. Identity document according to claim 18, wherein said reinforcement layer is a tissue reinforcement layer.

20. Identity document according to claim 19, comprising two thread directions at an angle of 90°.

21. Identity document according to claim 19, comprising two thread directions at an angle of approximately 60°.

22. Identity document according to claim 18, wherein said reinforcement layer comprises a web.

23. Identity document according to claim 18, wherein said reinforcement layer comprises multifilament threads.

24. Identity document according to claim 18, wherein said reinforcement layer is provided between two fused layers.

25. Identity document according to claim 18, wherein one of those layers comprises polycarbonate.

26. Identity document according to claim 18, wherein said layer comprises parallel threads and the distance between those threads being approximately 100 μm.

27. Identity document according to claim 18, wherein said perforation is made according to a pattern forming an image.

28. Identity document according to claim 27, wherein said pattern comprises a face.

29. Identity document according to claim 18, wherein said reinforcement layer comprises tissue reinforcements provided at a distance from each other, said perforation being provided between said tissue reinforcements.

30. Method for producing an identity document/bank card, comprising providing a carrier on which authenticity features are provided and making a personalized hole pattern in said carrier, the provision of said carrier comprising providing a thread reinforcement at the position of that subsequent hole pattern.

31. Method according to claim 30, wherein said provision of said thread reinforcement comprises providing a thread reinforcement web, placing a layer of plastic material on either side of it and fixing said layers of plastic material to each other.

32. Method according to claim 29, wherein fixing said layers to each other comprises fusing.

33. Method according to claim 30, wherein the provision of a carrier comprises finishing off the edges of said carrier.

34. Method according to claim 30, wherein the provision of a personalized hole pattern is performed by laser radiation.
